(19) United States
(12) Patent Application Publication
(10) Pub. No.: US 2014/0069687 A1
(43) Pub. Date: Mar. 13, 2014

(54) FOAMED SEPARATOR SPLINES FOR DATA COMMUNICATION CABLES

(71) Applicant: SABIC INNOVATIVE PLASTICS IP B.V., Bergen op Zoom (NE)

(72) Inventors: Glen Robert Tryson, Pittsfield, MA (US); Brian Rice, Huntersville, NC (US)

(73) Assignee: SABIC INNOVATIVE PLASTICS IP B.V., Bergen op Zoom (NE)

(21) Appl. No.: 13/843,208

(22) Filed: Mar. 15, 2013

Related U.S. Application Data
(60) Provisional application No. 61/699,532, filed on Sep. 11, 2012.

(51) Int. Cl. H01B 17/14; H01B 19/04

(52) U.S. Cl. CPC H01B 17/14; H01B 19/04
USPC 174/113 R; 174/146; 264/166

(57) ABSTRACT

A separator spline formed of a foamed, halogen-free polymeric material for separating twisted pairs of conductors is described. The isolator may take the shape of an “X”, a +, a rod, a star configuration, a tube or a flat rectangular shape, with the isolator separating twisted pairs of conductors. In the case of the “X”-shape, the twisted pairs are separated by the arms of the X. The halogen-free polymeric material is preferably selected from a resin selected from the group of polyetherimide (PEI), polyetherimide/polysiloxane copolymer, elastomer-modified-polyphenylene-ether blend, and combinations thereof. The isolator and twisted pairs are preferably part of a communication cable and being covered with a sheath.

### FIELD OF THE INVENTION

The invention is directed to foamed, electrically insulating separator splines for communication cables, communication cables incorporating the same, the processes for production thereof and use of such cables.

### BACKGROUND OF THE INVENTION

Present communication cables are formed of “twisted pairs” of conductors, usually metallic conductors, such as copper wire. These electrical conductors may each be covered with a nonconductive covering, such as synthetic polymers, natural or synthetic rubbers, and blends of electrically non-conductive materials. The resultant individual electrical conductors are then formed into the twisted pair, where at least two conductors are twisted forming interleaved spirals of conductors. When used to form communication cables, typically four twisted pairs are arranged about an electrically insulative isolator. Such an isolator is hereinafter referred to generically as a “separator spline”. In particular, a “separator spline” is an isolator having a four-arm shape, such as a cross (+-shape), or X-shape, and a flat tape-shape with each twisted pair lying in the space between the arms. However, the separator spline may also take other forms, as discussed further below. The purpose of the separator spline is to reduce“cross-talk” between each of the twisted pairs of electrical conductors, especially at high data transmission rates. The assembled separator spline and sets of twisted pairs can be covered in a sheath to form the completed communication cable.

The current materials of choice for the electrically insulative isolators are fluoropolymers or polyolefins, depending on cable construction and performance requirements.

In the present environment, the use of any type of halogenated compounds, especially fluorinated compounds presents an environmental hazard to be avoided. On the other hand, materials such as polyolefins present fire and smoke hazards, especially when used in an electrical environment. Thus, there is a need for separator splines which do not possess the detriments of the known separator spline materials.

### SUMMARY OF THE INVENTION

The invention provides a separator spline which is a non-halogen containing polymer having excellent smoke, flame and toxicity properties.

In one embodiment of the invention, the separator spline is formed of a polymeric material having excellent smoke flame and toxicity properties, such as polyetherimide (PEI), a polyetherimide/polysiloxane copolymer, a thermoplastic-elastomer-modified-polyphenylene-ether blend and combinations thereof.

In a further embodiment of the invention, the separator spline is formed of a reduced density material, such as foamed polyetherimide (PEI), a foamed polyetherimide/polysiloxane copolymer, a foamed thermoplastic-elastomer-modified-polyphenylene-ether blend and combinations thereof.

In a further embodiment of the invention foamed separator spline can be manufactured in indefinite lengths of up to 5000 meters and longer by continuous extrusion of a composition comprising polyetherimide (PEI), a polyetherimide/polysiloxane copolymer, a thermoplastic-elastomer-modified-polyphenylene-ether blend and combinations thereof, with a blowing agent, and optionally, a nucleating agent.

In a further embodiment of the invention an indefinite length, foamed separator spline can be manufactured by feeding preformed pellets of polyetherimide (Phi), a polyetherimide/polysiloxane copolymer, a thermoplastic-elastomer-modified-polyphenylene-ether blend and combinations thereof, with a blowing agent, and optionally, a nucleating agent, into a single screw extruder with a cross (+-shape) or “X”-shaped die, or rectangular-shaped die to produce a flat shape (with no cavities), to produce foamed extrudate, which can be drawn down, in a profile extrusion process.

In still further embodiments of the invention, the foamed separator spline can be combined with two or more twisted pairs, preferably four twisted pairs, of conductors nested in the spaces between the arms of the foamed separator spline, and the foamed isolator and twisted pairs being enclosed in a sheath to provide a lightweight non-halogen containing, data communication cable of low smoke, flame and toxicity properties, excellent in dielectric constant to reduce cross-talk between twisted pairs, suitable for use in high speed data transmission, and of acceptable compressive strength for use as data communication cables and components of data systems.

### BRIEF DESCRIPTION OF THE DRAWINGS

FIG. 1 is a pictorial representation of a prior art data communication cable;

FIG. 2 is a schematic representation of an “X” or cross +-shaped separator spline according to the invention;

FIG. 3 is a cross-sectional, schematic representation of an alternative shape for the separator spline of the present invention in the form of a rod;

FIG. 4 is a cross-sectional, schematic representation of a further alternative shape for the separator spline according to the present invention in the form of a star;

FIG. 5 is a cross-sectional, schematic representation of a further alternative shape for the separator spline according to the present invention in the form of a tube; and

FIG. 6 is a cross-sectional, schematic representation of a further alternative shape for the separator spline according to the present invention in the form of a flat rectangular shape.

### DETAILED DESCRIPTION OF THE PREFERRED EMBODIMENTS

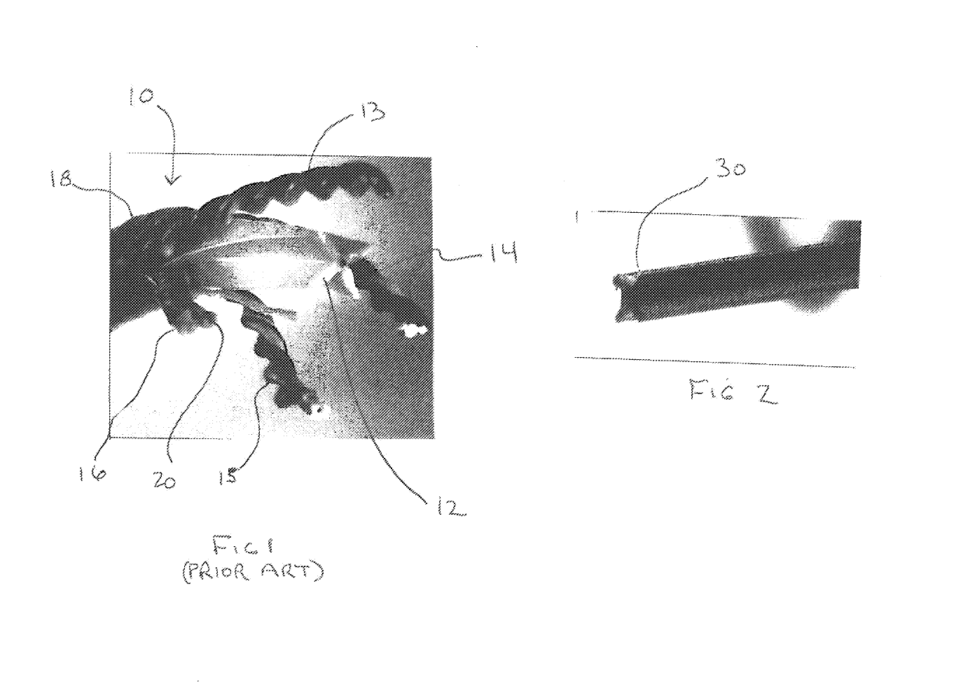

As shown in FIG. 1, a prior art data communication cable 10 is formed of a fluoropolymer separator spline 12 into which four twisted pairs 13, 14, 15 and 16 of conductors are nested. A sheath 18 surrounds the separator spline 12 and twisted pairs 13, 14, 15 and 16 to complete the communication cable 10. Each conductor 20 of the twisted pair may be independently covered in an electrically insulated manner. As an alternative to the fluoropolymer, a polyolefin can be used as the material for separator spline 12.

However, halogenated compounds (F, Cl, Br), may be environmentally harmful. Polyolefins present smoke, flame and toxicity hazards, especially in the electrical environment.

Thus, the present inventors have discovered that PEI resin can replace halogenated materials for improved smoke, flame and toxicity (SFT) properties meeting, or exceeding, regulatory requirements for data communications cable.¹ Although PEI is an electrically insulating material, it was further discovered that the dielectric constant of the PEI could be improve by introducing a chemical or physical blowing agent into the PEI to reduce its density and improve its dielectric constant. Density reduction of as little as 3% demonstrated improvement in dielectric constant. Density can be reduced even further until the physical properties of the resultant foamed separator spline (which can also be referred to as an “isolator”) are compromised, such as loss of mechanical integrity or buckling when bent. ¹ See for example the Underwriter's Laboratory Standard UL-910 Plenum Test, found in the Appendix hereto, or NFPA 262, both incorporated herein by reference in their entirety.

When the term “halogen-free” is used to describe a polymer, the term means that the polymer does not contain halogen atoms in the polymeric chain and no compounds added to the formulation which contains non-trace levels of halogen.

The present inventors have discovered that density reduction of from about 3% to about 62% represents the operative range with density reduction of from about 3% to about 55% being preferred. It is to be understood that dielectric performance of the separator spline improves as density decreases. The dielectric constant of solid (unfoamed) PEI is about 3.15 and the density reductions according to the invention can yield dielectric constants on the order of about 2.0.

Foaming of the PEI, or other polymers/copolymers or blends, suitable for use in the invention, can be achieved during melt processing into a shape suitable for the separator spline.

The separator spline 30 according to the invention is formed of a PEI resin (exemplified by ULTEM 1000 resin, commercially available from SABIC Innovative Plastics of Pittsfield, Mass.) which, during melt processing, is foamed by the addition of a chemical or physical blowing agent. A suitable blowing agent is dihydrooxadazinone in a PEI carrier, commercially available as ULTEM FUL-C20, from SABIC Innovative Plastics of Pittsfield, Mass. Preferably, a nucleating agent, such as talc, (commercially available as Ultra Talc 609 from Specialty Minerals Inc, of Bethlehem, Pa.), is included for improved bubble formation. In a most preferred embodiment, the PEI resin and nucleating agent have been previously processed in a compounding extruder to form pellets, which pellets are the feedstock for the extrusion process forming the separator spline extrudate. The nucleating agent can optionally be present, and when present, is preferably present in an amount of about 0.5% by weight, based on the weight of the PEI resin. In another embodiment, the amount of the nucleating agent can range from about 0.1 to 10% by weight, based on the weight of the PEI resin. When used, the blowing agent is preferably present in an amount of about 0.25% to about 1.0% by weight. In another embodiment, the amount of the blowing agent can range from about 0.05% to about 1.0%, by weight.

The present inventors have found that the resultant separator spline can be made from a PEI resin providing desirable smoke, flame and toxicity performance without halogen-containing materials. Furthermore, because the PEI resin is foamed during the forming of the separator spline, the presence of bubbles, which have a lower dielectric constant than that the neat resin, improves the dielectric constant of the separator spline over neat PEI resin to further inhibit cross talk between the twisted pairs, as well as reducing overall part weight without compromising physical properties of the resultant cable and providing a higher compressive strength as compared to fluoropolymers and polyolefins, improving the functionality of the separator spline to hold the conductors apart.

The separator spline of the invention in a preferred form comprises a separator spline having a length ranging from 1 meter to 5000 meters and a cross sectional dimension ranging from 0.1 mm to 5 mm, and a thickness ranging from 0.1 to 5 mm.

The foamed separator spline of the invention exhibits a compressive strength ranging from 15 to less than 124 Mpa, preferably a compressive strength of 27 to 84 MPa.

Although we have exemplified twisted pairs of conductors, it is to be expressly understood that the number of twisted pairs of conductors which are separated by the separator spline of the present invention is non-limiting and may typically range from two to sixteen twisted pairs.

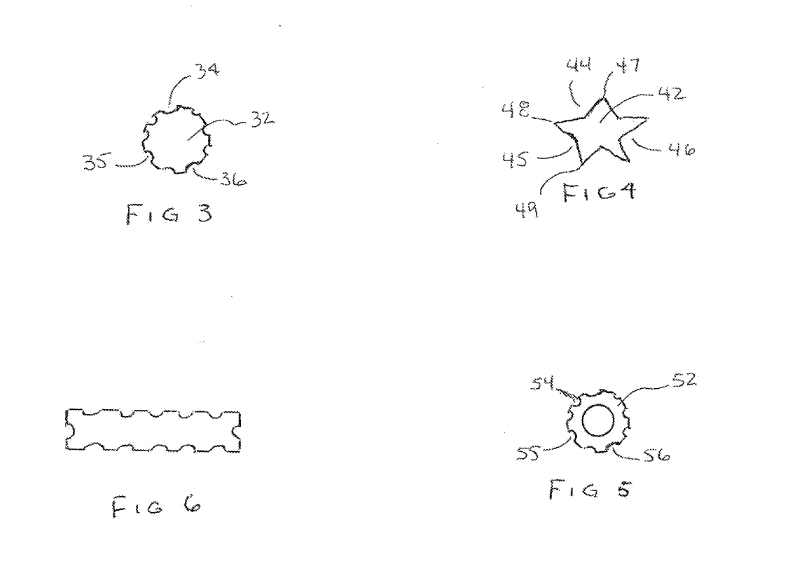

FIG. 3 illustrates separator spline 32 in the form of a rod having numerous cavities 34, 35, 36 to act as receptacles for a twisted pair. FIG. 4 shows the shape of the separator spline 42 as a star with several spaces 44, 45, 46 between the points 47, 48, 49 to accept a twisted pair. FIG. 5 illustrates a tube 52 having numerous cavities 54, 55, 56 to accept a twisted pair of conductors. FIG. 6 illustrates a flat rectangular shape 62 having numerous cavities 64, 65, 66 to accept a twisted pair of conductors. In another embodiment, flat separator splines, made according to our invention, have no cavities.

Technologies to foam PEI resins are described in published application US2007/0149629 A1, EP 0373402, U.S. Pat. Nos. 4,543,368; 4,683,247; 4,980,389; 5,064,867; 5,135, 959; 5,234,966 and 6,057,379, the entire disclosures of which are herein incorporated by reference.

Preferred polyimides include polyetherimides and polyetherimide copolymers. The polyetherimide can be selected from (i) polyetherimide homopolymers, e.g., polyetherimides, (ii) polyetherimide co-polymers, e.g., polyetherimide siloxane, and (iii) combinations thereof. Polyetherimides are known polymers and are sold by SABIC innovative Plastics under the ULTEM®* and SILTEM* brands (Trademark of SABIC Innovative Plastics IP B.V.).

In one embodiment, the polyetherimides are of formula (1):

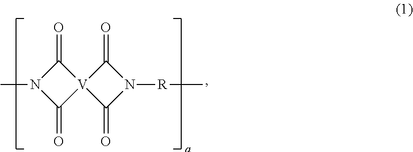

wherein a is more than 1, for example 10 to 1,000 or more, or more specifically 10 to 500.

The group V in formula (1) is a tetravalent linker containing an ether group (a “polyetherimide” as used herein) or a combination of an ether groups and siloxane groups (a “polyetherimide/siloxane”). Such linkers include but are not limited to: (a) substituted or unsubstituted, saturated, unsaturated or aromatic monocyclic and polycyclic groups having 5 to 50 carbon atoms, optionally substituted with ether groups, siloxane groups, or a combination of ether groups and siloxane groups; and (b) substituted or unsubstituted, linear or branched, saturated or unsaturated alkyl groups having 1 to 30 carbon atoms and optionally substituted with ether groups or a combination of ether groups, siloxane groups; or combinations comprising at least one of the foregoing. Suitable additional substitutions include, but are not limited to, ethers, amides, esters, and combinations comprising at least one of the foregoing.

The R group in formula (1) includes but is not limited to substituted or unsubstituted divalent organic groups such as: (a) aromatic hydrocarbon groups having 6 to 20 carbon atoms and derivatives thereof; (b) straight or branched chain alkylene groups having 2 to 20 carbon atoms; (c) cycloalkylene groups having 3 to 20 carbon atoms, or (d) divalent groups of formula (2):

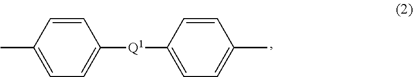

wherein Q¹ includes but is not limited to a divalent moiety such as —O—, —C(O)—, —SO₂—, —C_{y}H_{2y}— (y being an integer from 1 to 5), and derivatives thereof.

In an embodiment, linkers V include but are not limited to tetravalent aromatic groups of formula (3):

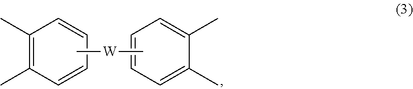

wherein W is a divalent moiety including —O—, —SO₂—, or a group of the formula wherein the divalent bonds of the —O— or the —O—Z—O— group are in the 3,3,3,4,4,3% or the 4,4′ positions, and wherein Z includes, but is not limited, to divalent groups of formulas (4):

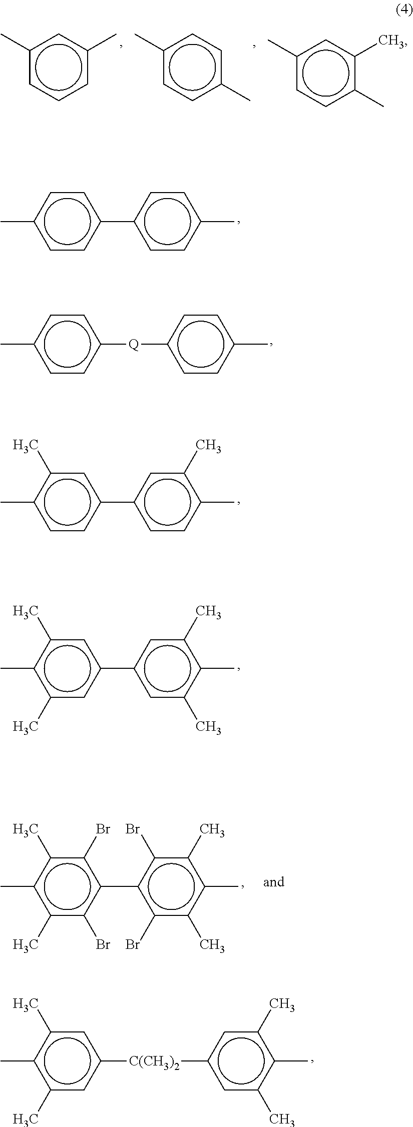

wherein Q includes, but is not limited to a divalent moiety including —O—, —S—, —C(O), —SO₂—, —SO—, —C_{y}H₂— (y being an integer from 1 to 5), and derivatives thereof.

In a specific embodiment, the polyetherimide comprise more than 1, specifically 10 to 1,000, or more specifically, 10 to 500 structural units, of formula (5):

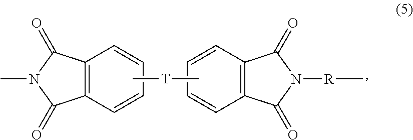

wherein T is —O— or a group of the formula —O—Z—O— wherein the divalent bonds of the —O— or the —O—Z—O— group are in the 3,3′, 3,4′, 4,3′, or the 4,4′ positions; Z is a divalent group of formula (3) as defined above; and R is a divalent group of formula (2) as defined above.

The polyetherimides can be synthesized by the reaction of the bis(phthalimide) (8) with an alkali metal salt of a dihydroxy substituted aromatic hydrocarbon of the formula HO—V—OH wherein V is as described above, in the presence or absence of phase transfer catalyst. Suitable phase transfer catalysts are disclosed in U.S. Pat. No. 5,229,482, incorporated herein by reference. Specifically, the dihydroxy substituted aromatic hydrocarbon a bisphenol such as bisphenol A, or a combination of an alkali metal salt of a bisphenol and an alkali metal salt of another dihydroxy substituted aromatic hydrocarbon can be used.

In one embodiment, the polyetherimide comprises structural units of formula (5) wherein each R is independently p-phenylene or m-phenylene or a mixture comprising at least one of the foregoing; and T is group of the formula —O—Z—O— wherein the divalent bonds of the —O—Z—O— group are in the 3,3′ positions, and Z is 2,2-diphenylenepropane group (a bisphenol A group).

The silicon polyetherimide can be any silicon-containing polyetherimide, which when used in accordance with the invention, enables the composition to exhibit a useful combination of improved flame retardancy, low smoke, and high impact strength properties, such that the compositions can pass the ASTM E 162 Standard Test Method for Surface Flammability of Materials Using a Radiant Heat Energy Source. Siloxane polyimide copolymers are a specific silicon polyetherimide that may be used in the blends of this invention. Examples of such siloxane polyimides are described in U.S. Pat. Nos. 5,028,681, 4,808,686, 4,690,997, 4,404,350, 4,051,163, 4,011,279, 3,847,867, 3,833,546 and 3,325,450, the entire disclosures of which are herein incorporated by reference. Siloxane polyimides can be prepared by standard methods to make polyimides wherein at least a portion, generally from 5 to 70 wt. %, and optionally from 10 to 50 wt. %, of the imide is derived from siloxane containing diamines, siloxane containing dianhydrides or chemical equivalents thereof. Such siloxane polyimides include SILTEM* resins, which can be obtained from SABIC Innovative Plastics (*Trademark of SABIC Innovative Plastics).

The siloxane polyimide can be prepared by any of the methods known to those skilled in the art, including the reaction of an aromatic bis(ether anhydride) of the Formula 6,

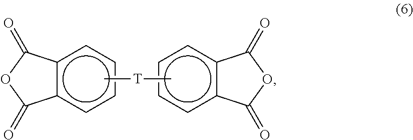

with an organic diamine of the Formula 7,

H₂N—R—NH₂ (7),

wherein T is a divalent moiety selected from the group consisting of —O—, —S—, —C(O)—, SO₂—, —SO, a direct linkage, a fused ring linkage, or a group of the formula —O—Z—O— wherein the divalent bonds of the -T- or the —O—Z—O— group are in the 3,3′, 3,4′, 4,3′, or the 4,4′ positions, and wherein Z includes, but is not limited, (a) aromatic hydrocarbon radicals having about 6 to about 36 carbon atoms and halogenated derivatives thereof including perfluoroalkylene groups; (b) straight or branched chain alkylene radicals having about 2 to about 24 carbon atoms (c) cycloalkylene radicals having about 3 to about 20 carbon atoms, or (d) divalent radicals of the general Formula 8:

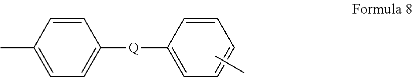

wherein Q includes but is not limited to a divalent moiety selected from the group consisting of —O—, —S—, —C(O)—, —SO₂—, —SO—, —C_{y}H_{2y}— (y being an integer from 1 to 8), and fluorinated derivatives thereof, including perfluoroalkylene groups, and wherein at least a portion of the reactants, either dianhydride, diamine, or mixtures thereof, contain a siloxane functionality. The moiety R in Formula 2 includes but is not limited to substituted or unsubstituted divalent organic radicals such as: (a) aromatic hydrocarbon radicals having about 6 to about 36 carbon atoms and halogenated derivatives thereof; (b) straight or branched chain alkylene radicals having about 2 to about 20 carbon atoms; (c) cycloalkylene radicals having about 3 to about 24 carbon atoms, or (d) divalent radicals of the general Formula 8.

Examples of suitable diamine compounds are ethylenediamine, propylenediamine, trimethylenediamine, decamethylenediamine, 1,12-dodecanediamine, 2,5-dimethylheptamethylenediamine, 2,2-dimethylpropylenediamine, N-methyl-bis(3-aminopropyl) amine, 3-methoxyhexamethylenediamine, 1,2-bis(3-aminopropoxy)ethane, bis(3-aminopropyl) sulfide, 1,4-cyclohexanediamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl)methane, bis(2-chloro-4-amino-3,5-diethylphenyl)methane, bis(4-aminophenyl) propane, 2,4-bis(p-amino-t-butyl) toluene, bis(p-amino-t-butylphenyl)ether, bis(p-methyl-o-aminophenyl)benzene, bis(p-methyl-o-aminopentyl)benzene, 1,3-diamino-4-isopropylbenzene, bis(4-aminophenyl) sulfide, bis(4-aminophenyl) sulfone, bis(4-aminophenyl)ether and 1,3-bis(3-aminopropyl)benzene. Mixtures comprising at least one of the foregoing compounds may also be used. In some embodiments, diamino compounds are aromatic diamines, especially m- and p-phenylenediamine, sulfonyl dianilines, bis aminophenoxy benzenes, bis amino phenoxy sulfones and mixtures comprising at least one of the foregoing diamines.

Examples of specific aromatic bis anhydrides and organic diamines are disclosed in U.S. Pat. Nos. 3,972,902 and 4,455,410. Illustrative examples of aromatic bis anhydrides include: 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, pyromellitic dianhydride, biphenyl dianhydride, oxy diphthalic anhydride, sulfone diphthalic anhydride, hydroquinone diphthalic anhydride, resorcinol diphthalic anhydride and mixtures comprising at least one of the foregoing compounds.

In one embodiment, the polyetherimides include a polyetherimide thermoplastic resin composition, comprising: (a) a polyetherimide resin, and (b) a phosphorus-containing stabilizer, in an amount that is effective to increase the melt stability of the poly etherimide resin, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300° C. at a heating rate of a 20° C. per minute under an inert atmosphere. In one embodiment, the phosphorous-containing stabilizer has a formula P—R′ₐ, where R′ is independently H, alkyl, alkoxy, aryl, aryloxy, or oxy substituent and a is 3 or 4. Examples of such suitable stabilized polyetherimides can be found in U.S. Pat. No. 6,001,957, incorporated herein in its entirety.

As such, the invention includes an embodiment in which the separator spline comprises an amorphous polymer composition comprising (a) a polyetherimide resin, and (b) a phosphorus-containing stabilizer, in an amount that is effective to increase the melt stability of the polyetherimide resin, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300° C. at a heating rate of a 20° C. per minute under an inert atmosphere. In one embodiment, the article is made such that the phosphorous-containing stabilizer has a formula P—R′ₐ, where R′ is independently H, alkyl, alkoxy, aryl, aryloxy, or oxy substituent and a is 3 or 4.

The polyimide siloxanes can also be prepared in a manner similar to that used for polyimides, except that a portion, or all, of the organic diamine reactant is replaced by an amine-terminated organo siloxane, for example of the Formula 9 wherein g is an integer from 1 to about 100, optionally from about 5 to about 50, and R′ is an aryl, alkyl or aryl alky group of from 2 to 20 carbon atoms.

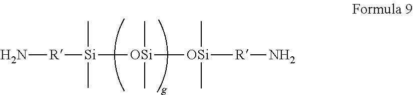

Some polyimide siloxanes may be formed by reaction of an organic diamine, or mixture of diamines, and the amine-terminated organo siloxane of Formula 9, and one or more dianhydrides. The diamino components may be physically mixed prior to reaction with the bis-anhydride(s), thus forming a substantially random copolymer. Alternatively block or alternating copolymers may be formed by selective reaction of 4 with dianhydrides to make polyimide blocks that are subsequently reacted together. In another instance the siloxane used to prepare the polyimide copolymer may have anhydride rather than amine functional end groups, for example as described in U.S. Pat. No. 4,404,350, the entire disclosure of which is herein incorporated by reference.

In another embodiment the siloxane polyimide copolymer can be of Formula 10 wherein T, R′ and g are described as above with regard to Formula 9, n is from 5 to about 100 and Ar is an aryl or alkyl aryl group of from 6 to 36 carbons.

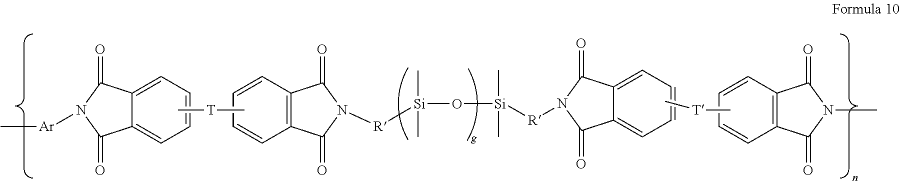

In some siloxane polyetherimides the diamine component of the siloxane polyetherimide copolymers may contain from about 5 to 70 wt. % of the amine-terminated organo siloxane of Formula 9 and from about 30 to 95 wt. % of the organic diamine of Formula 7. In some siloxane copolymers, the siloxane component contains from about 25 to about 40 wt. % of the amine or anhydride terminated organo siloxane.

In some embodiments the siloxane polyimides can be siloxane polyetherimides which contain aryl ether linkages that can be derived by polymerization of dianhydrides and/or diamines wherein at least a portion of the dianhydride or the diamine contains an aryl ether linkage. In some instances both the diamine and dianhydride will contain an aryl ether linkage and at least a portion of the diamine or dianhydride will contain siloxane functionality, for example as described above. In other embodiments the aryl ether linkage can de derived from dianhydrides such as bisphenol A diphthalic anhydride, biphenol diphthalic anhydride, oxy diphthalic anhydride or mixtures thereof. In still other siloxane polyetherimides the aryl ether linkages can be derived from at least one diamine containing aryl ether linkages, for example, diamino diphenyl ethers, bis amino phenoxy benzenes, bis amino phenoxy phenyl sulfones or mixtures thereof. Either the diamine or dianhydride may have aryl ether linkages or in some instances both monomers may contain aryl ether linkages.

The silicone polyetherimide can have from about 5 to about 50, from about 10 to about 40, or from about 20 to about 30 percent by weight dimethyl siloxane units.

The silicone polyetherimide can have less than about 100, less than about 75, or from 10 to about 50 ppm amine end groups;

The silicone polyetherimide can have a weight average molecular weight from about 5,000 to about 70,000, from about 10,000 to about 60,000, or from about 20,000 to about 50,000 Daltons.

The articles of the invention can be made by any suitable method. For instance, the separator splines of the invention can be made by extruding. In other embodiments, the separator splines can be made by a method for making an article comprising extruding, injection molding, compressing molding, machining, and/or film pressing. In another embodiment separator splines can be made by additive manufacturing techniques.

In embodiments where additive manufacturing techniques are used to make separator splines, our separator spline can be made by any suitable process that uses additive manufacturing strategies. In one embodiment, our invention includes a method for building a three-dimensional separator spline in an extrusion-based digital manufacturing system, the method comprising: providing a consumable filament of the polymeric material to the extrusion-based digital manufacturing system, the consumable filament having a length, an exterior surface, and a plurality of tracks along at least a portion of the length, wherein the plurality of tracks provide a fractal dimensionality for at least a portion of the exterior surface that is greater than two for a suitable length scale, e.g., a length scale between 0.01 millimeters and 1.0 millimeter; engaging teeth of a rotatable drive mechanism retained by the extrusion-based digital manufacturing system with the plurality of tracks of the consumable filament; feeding successive portions of the consumable filament with the rotatable drive mechanism to a liquefier retained by the extrusion-based digital manufacturing system, wherein successive teeth of the rotatable drive mechanism are continuously engaged with successive tracks of the plurality of tracks while feeding the successive portions of the consumable filament; melting the consumable filament in the liquefier to provide a melted consumable material; extruding the melted consumable material from the liquefier; and depositing the extruded consumable material in a layer-by-layer manner to form at least a portion of the separator spline, which can generate back pressure in the liquefier. The consumable filament can be made by any suitable geometry. In one embodiment, the consumable filament has a substantially cylindrical geometry with an average diameter ranging from about 1.143 millimeters to about 2.54 millimeters. In another embodiment, the consumable filament has a substantially rectangular cross-sectional profile. The plurality of tracks can be selected from the group consisting of rectangular tracks, parabolic tracks, worm-type tracks, corrugated tracks, textured tracks, impressed file-type tracks, herringbone-type tracks, sprocket tracks, edge-facing tracks, staggered tracks, and combinations thereof.

As such, our invention includes an embodiment in which the separator spline is made in an extrusion-based digital manufacturing system, the method comprising: providing a consumable filament of the polymeric material to the extrusion-based digital manufacturing system, the consumable filament having a length, an exterior surface, and a plurality of tracks along at least a portion of the length, wherein the plurality of tracks provide a fractal dimensionality for at least a portion of the exterior surface that is greater than two for a length scale between 0.01 millimeters and 1.0 millimeter; engaging teeth of a rotatable drive mechanism retained by the extrusion-based digital manufacturing system with the plurality of tracks of the consumable filament; feeding successive portions of the consumable filament with the rotatable drive mechanism to a liquefier retained by the extrusion-based digital manufacturing system, wherein successive teeth of the rotatable drive mechanism are continuously engaged with successive tracks of the plurality of tracks while feeding the successive portions of the consumable filament;

melting the consumable filament in the liquefier to provide a melted consumable material; extruding the melted consumable material from the liquefier; and depositing the extruded consumable material in a layer-by-layer manner to form at least a portion of the separator spline. A suitable apparatus for carrying out this method is disclosed in U.S. Pat. No. 8,236,227, the entire disclosure of which is herein incorporated by reference.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure. Numerical ranges include all values within the range. For example, a range of from 1 to 10 supports, discloses, and includes the range of from 4.5 to 9.7. Similarly, a range of at least 10 supports, discloses, and includes the range of at least 15.

Unless expressly specified herein, all percentages are percent by weight. All molecular weights are weight average molecular weight unless otherwise specified herein.

### EXAMPLES

The following Examples and Comparative Examples are not limiting but are provided to assist the ordinary worker skilled in the art to which this invention pertains to practise the best mode of the invention.

### Purpose:

Produce an extruded shape from foamed polyetherimide (PEI) resin which could be used as a separator spline in a cable construction.

### Materials

| COMPONENT | CHEMICAL DESCRIPTION | SOURCE, VENDOR |
|---|---|---|
| ULTEM 1000 | Polyetherimide (PEI) resin | SABIC |
| Talc | Ultra Talc 609 | SABIC - internal |
| | | code F5022 |
| ULTEM | A dihydrooxadiazinone in a | SABIC |
| FUL-C20 | PEI resin carrier - a | |
| | chemical blowing agent | |

### Techniques and Procedures

ULTEM 1000 resin was combined with 0.5% talc by weight using a twin screw extruder and standard polyetherimide resin compounding conditions to produce a compound used in subsequent extrusion trials to produce foamed parts.

In the following Comparative and Examples 1-5 of the invention, an Akron single-screw extruder (2 inch screw diameter, L/D=24, 3:1 compression ratio) was used with an “X”-shaped die to produce neat (non-foamed) and foamed parts with a PEI resin compound. Nominal dimensions of the die were 0.220 inch by 0.220 inch (designed to be used with polyethylene to produce a part 0.130 inch by 0.130 inch with a wall thickness of 0.018 inch when drawn down in a profile extrusion process). The extruder was operated with a temperature profile of 327-343-343-343° C., progressing from the feed zone to the die, at a screw speed of 25 rpm. Puller speed was varied to achieve target dimensions.

A blowing agent (ULTEM FUL-C20) (with 0.5 wt % talc) in various amounts was used in preparing the foamed separator splines according to the invention.

### Example 1 (Comparative Example)

A polyetherimide (PEI) resin, commercially available as ULTEM 1000 from SABIC Innovative Plastics was used as a baseline, with no blowing agent or introduced air bubbles (a neat resin). The PEI was fed to the Akron single screw extruder under the conditions specified above to obtain an +-shaped extrudate having a relative linear density of 100%, an apparent specific gravity of 1.27 and a density reduction of 0%. The weight of a 1 meter length of extrudate was 4.6669 gram. Its properties are as set forth in Table 1 below.

### Example 2

The same PEI as used in example 1 above was combined with a blowing agent (a dihydrooxadiazinone in a PEI carrier, commercially available as ULTEM FUL-C20 from SABIC Innovative Plastics) in an amount of 11.4 gm/4540 gm PEI resin, and extruded in the Akron single screw extruder under the conditions specified above. The resultant extrudate exhibited a relative linear density of 91%, an apparent specific gravity of 1.23 and a density reduction of 3%. It exhibited a slight foaming. Its properties are as set forth in Table 1 below.

### Example 3

The same PEI as used in example 1 above was combined with a blowing agent (a dihydrooxadiazinone in a PEI carrier, commercially available as ULTEM FUL-C20 from SABIC Innovative Plastics) in an amount of 17.1 gm/4540 gm PEI resin, and extruded in the Akron single screw extruder under the conditions specified above. The resultant extrudate exhibited a relative linear density of 79%, an apparent specific gravity of 1.01 and a density reduction of 21%. It exhibited foaming with good mechanical properties. Its properties are as set forth in Table 1 below.

### Example 4

The same PEI as used in example 1 above was combined with a blowing agent (a dihydrooxadiazinone in a PEI carrier, commercially available as ULTEM FUL-C20 from SABIC Innovative Plastics) in an amount of 22.8 gm/4540 gm PEI resin, and extruded in the Akron single screw extruder under the conditions specified above. The resultant extrudate exhibited a relative linear density of 46%, an apparent specific gravity of 0.57 and a density reduction of 55%. It exhibited significant foaming but the separator spline buckled when bent. Its properties are as set forth in Table 1 below.

### Example 5

The same PEI as used in example 1 above was combined with a blowing agent (a dihydrooxadiazinone in a PEI carrier, commercially available as ULTEM FUL-C20 from SABIC Innovative Plastics) in an amount of 45.4 gm/4540 gm PEI resin, and extruded in the Akron single screw extruder under the conditions specified above. The resultant extrudate exhibited a relative linear density of 42%, an apparent specific gravity of 0.48 and a density reduction of 62%. It exhibited loss of mechanical integrity, could not get into dimension with line speed. Its properties are as set forth in Table 1 below.

TABLE 1

| | | FUL- | | | | | | | | | |
|---|---|---|---|---|---|---|---|---|---|---|---|
| | FUL- | C20 | | | | | | | | | |
| | C20 | Loading | Line | Weight of | Dim 1 | Dim 2 | Wall | Relative | Apparent | Density | Comments |
| Run | Loading | (gm/4540 | Speed | 1 meter piece | | | Thickness | Linear | Specific | Reduction | |
| Number | (%) | gm resin) | (m/sec) | (gm) | (mm) | (mm) | (mm) | Density | Gravity | (%) | |
| 1 | 0.00 | 0 | 0.81 | 4.6669 | 3.28 | 3.23 | 0.64 | 100% | 1.27 | 0 | No blowing |
| | | | | | | | | | | | agent - baseline |
| 2 | 0.25 | 11.4 | 0.81 | 4.2701 | 3.05 | 3.20 | 0.58 | 91% | 1.23 | 3 | Slight foaming |
| 3 | 0.38 | 17.1 | 0.85 | 3.6906 | 3.28 | 3.30 | 0.61 | 79% | 1.01 | 21 | Foaming, |
| | | | | | | | | | | | mechanicals good |
| 4 | 0.50 | 22.8 | 1.61 | 2.1339 | 3.35 | 3.43 | 0.66 | 46% | 0.57 | 56 | Significant |
| | | | | | | | | | | | foaming, isloator |
| | | | | | | | | | | | buckles when |
| | | | | | | | | | | | bent |
| 5 | 1.00 | 45.4 | >1.61 | 1.9694 | 3.68 | 3.66 | 0.56 | 42% | 0.48 | 62 | Loss of |
| | | | | | | | | | | | mechanical |
| | | | | | | | | | | | integrity, couldn't |
| | | | | | | | | | | | get into dimension |
| | | | | | | | | | | | with line speed |

Discussion:

The above examples demonstrate the ability to produce a reduced density part from PEI resin which could function as a separator spline in a cable construction. With blowing agent loadings of 0.38% and 0.5%, density reductions of 21% and 56% respectively were achieved. Parts were produced which met targeted dimensions for the +-shaped cross-section. One skilled in the art of profile extrusion die design and processing would be able to optimize equipment and process conditions to produce other specified dimensions.

Although we have described the extrusion of separator splines having a +-shape or an X-shape, and a flat tape-shape to separate each of four twisted pairs of conductors, it is within the scope of the invention to provide other shapes of isolators (separator splines) to serve to isolate different numbers of twisted pairs in data communication cables. These can take the form of a rod, a star configuration, a tube, or a flat rectangular shape.

### Example 6

### Purpose

To examine different chemical blowing agents to determine suitability for use with polyetherimide resin in an extrusion process.

### Materials

| COMPONENT | CHEMICAL DESCRIPTION | SOURCE, VENDOR |
|---|---|---|
| ULTEM 1010 | Polyetherimide (PEI) resin | SABIC |
| ULTEM | A dihydrooxadiazinone in a | SABIC |
| FUL-C20 | PEI resin carrier | |
| Safoam NPC-20 | Proprietary endothermic | Reedy International |
| | chemical blowing agent | Corporation |
| Safoam RPC-40 | Proprietary endothermic | Reedy International |
| | chemical blowing agent | Corporation |

### Techniques and Procedures

A Killion single-screw extruder (25 mm screw diameter, L/D=24, barrier screw design) was used with a circular (rod) die to produce foamed parts. Nominal dimension of the die opening was 1.0 mm. The extruder was operated with a temperature profile and screw speed as shown in the data table below. The extruded strand of material was allowed to collect on the floor below the die.

Different chemical blowing agents (detailed in the Materials Table above) were blended with ULTEM 1010 polyetherimide resin at a level of 2.0% by weight and passed through the extruder to produce a strand of foamed material.

Dimensions of extruded parts were measured using a standard set of calipers with precision of 0.001″. Weights of extruded parts were determined using a Mettler analytical balance with precision of 0.0001 gm. Apparent specific gravity and density reduction were calculated from these measurements.

### Results:

Table 2 below shows results from several extrusion runs with different chemical blowing agents added to PEI resin and extruded.

TABLE 2

| | | Extruder Temperature | | | | | | |
|---|---|---|---|---|---|---|---|---|
| | | Settings | | BA | Talc | Density | Density | |
| Run | | Feed Zone ==> | Screw | Level | Level | (gm/ | Reduction | |
| No. | Material | Die (C.) | RPM | (Wt. %) | (Wt. %) | cm\hat{ }3) | (%) | Comments |
| 0 | ULTEM 1010 | 316-327-327- | 10 | 0 | 0 | 1.27 | 0 | Baseline - No foaming |
| | | 327-327-332 | | | | | | |
| 1 | ULTEM 1010 + | 316-327-327- | 10 | 2 | 0 | 0.42 | 67 | Amount of foaming varying - |
| | 2% FUL-C20 | 327-327-332 | | | | | | possible incomplete mixing |
| 2A | ULTEM 1010 + | 316-327-327- | 10 | 2 | 0 | 1.11 | 13 | Coarse bubbles - less foaming |
| | 2% NPC-20 | 327-327-332 | | | | | | than FUL-C20 |
| 2B | ULTEM 1010 + | 316-327-327- | 15 | 2 | 0 | 1.08 | 15 | Higher throughput - similar foaming |
| | 2% NPC-20 | 327-327-332 | | | | | | |
| 3A | ULTEM 1010 + | 316-327-327- | 10 | 2 | 0 | 1.27 | 0 | Low pressure and throughput rate. |
| | 2% RPC-40 | 327-327-332 | | | | | | Clumping of ULTEM to BA pellets |
| 3B | ULTEM 1010 + | 316-327-327- | 20 | 2 | 0 | — | — | No sample retained - not foaming |
| | 2% RPC-40 | 327-327-332 | | | | | | |

### Discussion:

The above examples demonstrate the efficacy of different chemical blowing agents for producing polyetherimide foam in an extrusion process. The ULTEM FUL-C20 compound is very effective, NPC-20 compound produces foam but is less effective, and RPC-40 is not suited for producing PEI foam.

### Example 7

### Purpose:

Examine the effects of adding a nucleating agent (talc) to polyetherimide resin and a chemical blowing agent to produce foam in an extrusion process.

### Materials

| COMPONENT | CHEMICAL DESCRIPTION | SOURCE, VENDOR |
|---|---|---|
| ULTEM 1000 | Polyetherimide (PEI) resin | SABIC |
| Talc | Ultra Talc 609 | SABIC - internal |
| | | code F5022 |
| ULTEM | A dihydrooxadiazinone in a | SABIC |
| FUL-C20 | PEI resin carrier | |
| Safoam NPC-20 | Proprietary endothermic | Reedy International |
| | chemical blowing agent | Corporation |

### Techniques and Procedures

ULTEM 1000 resin was combined with 0.5% talc by weight using a twin screw extruder and standard polyetherimide resin compounding conditions to produce a compound used in subsequent extrusion trials to produce foamed parts.

A Killion single-screw extruder (25 mm screw diameter, L/D=24, barrier screw design) was used with a circular (rod) die to produce foamed parts. Nominal dimension of the die opening was 1.0 mm. The extruder was operated with a temperature profile and screw speed as shown in the data table below. The extruded strand of material was allowed to collect on the floor below the die.

Different chemical blowing agents (detailed in the Materials Table above) were blended with a polyetherimide resin/0.5% talc compound at a level of 2.0% by weight and passed through the extruder to produce a strand of foamed material.

Dimensions of extruded parts were measured using a standard set of calipers with precision of 0.001″. Weights of extruded parts were determined using a Mettler analytical balance with precision of 0.0001 gm. Apparent specific gravity and density reduction were calculated from these measurements.

### Results:

Table 3 below shows results from extrusion runs with different chemical blowing agents added to a PEI resin/talc compound and extruded.

TABLE 3

| | | Extruder Temperature | | | | | | |
|---|---|---|---|---|---|---|---|---|
| | | Settings | | BA | Talc | Density | Density | |
| Run | | Feed Zone ==> | Screw | Level | Level | (gm/ | Reduction | |
| No. | Material | Die (C.) | RPM | (Wt. %) | (Wt. %) | cm\hat{ }3) | (%) | Comments |
| 1 | ULTEM 1000 | 316-332-343- | 8 | 0 | 0 | 1.27 | 0 | Baseline - No foaming |
| | | 343-343-343 | | | | | | |
| 2 | ULTEM 1000 + | 316-332-332- | 8 | 2 | 0 | — | — | Foaming variable - sample not |
| | 2.0% FUL-C20 | 335-335-338 | | | | | | consistent - had to lower temps |
| 3 | ULTEM 1000 + | 316-332-332- | 8 | 2 | 0.5 | 0.46 | 63 | Smaller, more uniform bubbles |
| | 0.5% talc + | 335-335-338 | | | | | | with talc |
| | 2.0% FUL-C20 | | | | | | | |
| 4 | ULTEM 1000 + | 316-332-332- | 8 | 2 | 0.5 | 0.69 | 48 | Smaller, more uniform bubbles |
| | 0.5% talc + | 335-335-338 | | | | | | with talc - less density reduction |
| | 2.0% NPC-20 | | | | | | | compared to FUL-C20 |

### Discussion:

The above examples illustrate that adding talc at a low level to polyetherimide resin and a chemical blowing agent results in uniform foam when extruded. In addition to stabilizing the extrusion process, the nucleating agent may also enhance the degree of foaming for a given level of blowing agent.

### Example 8

### Purpose:

To produce foamed parts in an extrusion process using a polyetherimide/siloxane copolymer (SILTEM* brand resin) with a chemical blowing agent.

### Materials

| COMPONENT | CHEMICAL DESCRIPTION | SOURCE, VENDOR |
|---|---|---|
| ULTEM 1000 | Polyetherimide (PEI) resin | SABIC |
| ULTEM | Polyetherimide/siloxane | SABIC |
| STM1700 | copolymer | |
| ULTEM | A dihydrooxadiazinone in a PEI | SABIC |
| FUL-C20 | resin carrier | |

### Techniques and Procedures

A Killion single-screw extruder (25 mm screw diameter, L/D=24, barrier screw design) was used with a circular (rod) die to produce foamed parts. Nominal dimension of the die opening was 1.0 mm. The extruder was operated with a temperature profile and screw speed as shown in the data table below. The extruded strand of material was allowed to collect on the floor below the die.

ULTEM FUL-C20 chemical blowing agent was blended with a polyetherimide/siloxane copolymer at a level of 2.0% by weight and passed through the extruder to produce a strand of foamed material.

Dimensions of extruded parts were measured using a standard set of calipers with precision of 0.001″. Weights of extruded parts were determined using a Mettler analytical balance with precision of 0.0001 gm. Apparent specific gravity and density reduction were calculated from these measurements.

### Results:

Table 4 below shows results from extrusion runs with polyetherimide resin and with a polyetherimide/siloxane copolymer plus chemical blowing agent.

TABLE 4

| | | Extruder Temperature | | | | | | |
|---|---|---|---|---|---|---|---|---|
| | | Settings | | BA | Talc | Density | Density | |
| Run | | Feed Zone ==> | Screw | Level | Level | (gm/ | Reduction | |
| No. | Material | Die (C.) | RPM | (Wt. %) | (Wt. %) | cm\hat{ }3) | (%) | Comments |
| 1 | ULTEM 1000 | 316-332-332- | 8 | 0 | 0 | 1.27 | 0 | Baseline - No foaming |
| | | 335-335-338 | | | | | | |
| 5 | ULTEM STM1700 | 299-299-304- | 10 | 0 | 0 | 1.20 | 0 | Baseline - No foaming |
| | | 304-304-304 | | | | | | |
| 6 | ULTEM STM1700 + | 299-299-304- | 10 | 2 | 0 | 0.55 | 54 | Coarse bubbles |
| | 2.0% FUL-C20 | 304-304-304 | | | | | | |
| 6A | ULTEM STM1700 + | 299-299-304- | 20 | 2 | 0 | 0.59 | 51 | Coarse bubbles |
| | 2.0% FUL-C20 | 304-304-304 | | | | | | |

### Discussion:

The above examples illustrate that ULTEM FUL-C20 is effective as a blowing agent for a polyetherimide/siloxane copolymer in an extrusion process. Based on the findings illustrated by Example 8 above, it is expected that the addition of talc to this system will improve the quality of the foam.

### Example 9

The purpose of this example was to make a separator spline with additive manufacturing techniques.

### Techniques and Procedures

The separator spline was made in an extrusion-based digital manufacturing system as follows. A consumable filament of polyetherimide sold commercially as Ultem 9085 resin, manufactured and sold by SABIC Innovative Plastics, US LLC, was provided to an extrusion-based digital manufacturing system purchased from Stratysys, Inc and known as FORTUSTM-400 mc.

The consumable filament had a length, an exterior surface, and a plurality of tracks along at least a portion of the length, such that the plurality of tracks provided a fractal dimensionality for at least a portion of the exterior surface that is greater than two for a length scale between 0.01 millimeters and 1.0 millimeter. The teeth of a rotatable drive mechanism retained by the extrusion-based digital manufacturing system engaged with a rotatable drive mechanism with the plurality of tracks of the consumable filament. Portions of the consumable filament were fed successively with the rotatable drive mechanism to a liquefier retained by the extrusion-based digital manufacturing system. Successive teeth of the rotatable drive mechanism were continuously engaged with successive tracks of the plurality of tracks while feeding the successive portions of the consumable filament. The consumable filament melted in the liquefier to provide a melted consumable material. The melted consumable material from the liquefier was extruded and the extruded consumable material was deposited in a layer-by-layer manner to form the separator spline.

### Results:

The additive manufacturing process described above was used to fabricate parts with an “X” cross-section with nominal dimensions of 4.7 mm tip-to-tip and fin thickness of nominally 1.0 mm. The fabricated parts had a nominal length of 127 mm. Different machine settings were used (changing contour and raster dimensions) to produce parts which varied in mass from 1.03 to 1.20 gm.

This length was limited by the dimensional capabilities of the equipment used, and it should be appreciated that longer lengths could be fabricated with appropriately sized equipment.

### Discussion:

The above example illustrates that separator spline parts can be fabricated using an additive manufacturing process. Our results show that additive manufacturing processes make articles having reduced density, as compared with separator splines that are solid and made from ULTEM 9085 resin and that have the same dimensions as those made from the additive manufacturing process. The expected weight of a solid part with the described dimensions fabricated with ULTEM 9085 resin, for instance, is 1.43 gm. As such, the separator splines made by additive manufacturing represented a density reduction ranging from 16% to 28%. No blowing agent was used in this process so the density reduction is due to the open lattice structure produced as material is placed by the additive manufacturing equipment.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, all such modifications and equivalents are believed to be within the spirit and scope of the invention defined by the following claims.

We claim:

1. An article comprising a foamed, polymeric, separator spline shaped to isolate at least one twisted pair of conductors.

2. The article according to claim 1, wherein the foamed separator spline has a reduced density as compared to a non-foamed solid, separator spline.

3. The article according to claim 1, wherein the foamed polymeric separator spline is one selected from the group consisting of a foamed polyetherimide (PEI), a foamed polyetherimide/polysiloxane copolymer, a foamed thermoplastic-elastomer-modified-polyphenylene-ether blend, and combinations thereof.

4. The article of claim 1, wherein the separator spline has a length ranging from 1 meter to 5000 meters and a cross sectional dimension ranging from 0.1 mm to 5 mm, and a thickness ranging from 0.1 to 5 mm.

5. The article of claim 1, wherein the shape of the separator spline is selected from one of the following shapes: (i) a +, (2) an X, (iii) a rod, (iv) a star configuration, (v) tube, (vi) flat rectangular.

6. The article of claim 1, wherein the separator spline comprises a foamed polyetherimide (PEI) having a density reduction as compared to solid PEI ranging from about 3% to about 65%.

7. The article of claim 1, wherein the separator spline comprises a foamed polyetherimide (PEI) having a density reduction as compared to solid PEI ranging from about 3% to about 55%.

8. A cable comprising the separator spline of claim 1 and a plurality of the twisted conductor pairs encased in a sheath.

9. The cable of claim 8, wherein the cable meets or exceeds at least one of UL-910 Plenum Test and NFPA 262.

10. The cable of claim 8, wherein the cable is a data communication cable and the plurality of twisted conductor pairs is equal to four.

11. The cable of claim 8, wherein the sheath also comprises one selected from the group consisting of a foamed polyetherimide (PEI), a foamed polyetherimide/polysiloxane copolymer, a foamed thermoplastic-elastomer-modified-polyphenylene-ether blend, and combinations thereof.

12. An article comprising a halogen-free separator spline for isolating at least two twisted pair of communication conductors to reduce cross-talk between the conductors, the article comprising:
two twisted pairs of communication conductors,
a foamed, halogen-free separator spline, the separator spline being interposed between the two pairs of communication conductors,
the separator spline comprising a foamed polyetherimide (PEI) or a polyetherimide/siloxane copolymer, wherein the foam reduces the density, as compared to a corresponding non-foamed resin, in the range of about 3% to about 55%.

13. The article of claim 12, further comprising a sheath covering the separator spline and the communication conductors.

14. A lightweight, flame and smoke retardant communication cable comprising at least two twisted pairs of communication conductors, separated by a halogen-free, foamed polymeric separator spline, the twisted pairs and spline being sheathed by an outer covering.

15. The communication cable of claim 14, wherein the at least two twisted pairs range from two to sixteen twisted pairs.

16. The communication cable of claim 14, wherein the foamed separator spline has a compressive strength ranging from 15 to less than 124 MPa.

17. The communication cable of claim 12, wherein the foamed separator spline has a compressive strength of 27 to 84 MPa.

18. A communication cable comprising a plurality of twisted conductor pairs, the conductor pairs being separated by a separator spline, wherein the separator spline has improved smoke, flame, and reduced toxicity properties; wherein the separator spline comprises a melt processed, foamed, polyetherimide (PEI) component selected from the group of polyetherimide homopolymers, polyetherimide copolymers, and combinations thereof, the separator spline having a reduced density, as compared to non-foamed PEI, of from about 3% to about 55%.

19. The communication cable of claim 18, wherein the polyetherimide copolymer comprises a polyetherimide/polysiloxane copolymer.

20. The communication cable of claim 18, wherein the dielectric constant of the separator spline material is from about 2.0 to less than 3.15.

21. The communication cable of claim 18, wherein the foamed PEI has a compressive strength ranging from 27 to 84 MPa.

22. The communication cable of claim 18, wherein the separator spline has a shape selected from the group consisting of an +-shape, an X-shape, and a flat tape-shape.

23. The communication cable of claim 21, wherein one twisted pair of conductors is present in each of the arms of the + and the X.

24. A method for making the article of claim 1, comprising extruding a composition through a shaped die, the composition comprising (i) a blowing agent, (ii) a thermoplastic resin selected from the group of polyetherimide (PEI), polyetherimide/polysiloxane copolymer, elastomer-modified-polyphenylene-ether blend, and combinations thereof, and optionally a nucleating agent.

25. The article of claim 1, wherein the separator spline is made in an extrusion-based digital manufacturing system, the method comprising:
providing a consumable filament of the polymeric material to the extrusion-based digital manufacturing system, the consumable filament having a length, an exterior surface, and a plurality of tracks along at least a portion of the length, wherein the plurality of tracks provide a fractal dimensionality for at least a portion of the exterior surface that is greater than two for a length scale between 0.01 millimeters and 1.0 millimeter;
engaging teeth of a rotatable drive mechanism retained by the extrusion-based digital manufacturing system with the plurality of tracks of the consumable filament;
feeding successive portions of the consumable filament with the rotatable drive mechanism to a liquefier retained by the extrusion-based digital manufacturing system, wherein successive teeth of the rotatable drive mechanism are continuously engaged with successive tracks of the plurality of tracks while feeding the successive portions of the consumable filament;
melting the consumable filament in the liquefier to provide a melted consumable material;
extruding the melted consumable material from the liquefier; and
depositing the extruded consumable material in a layer-by-layer manner to form at least a portion of the separator spline.

26. The article of claim 1, wherein the separator spline comprises an amorphous polymer composition comprising (a) a polyetherimide resin, and (b) a phosphorus-containing stabilizer, in an amount that is effective to increase the melt stability of the polyetherimide resin, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300° C. at a heating rate of a 20° C. per minute under an inert atmosphere.

27. The article of claim 26, wherein the phosphorous-containing stabilizer has a formula P—R′ₐ, where R′ is independently H, alkyl, alkoxy, aryl, aryloxy, or oxy substituent and a is 3 or 4.
